(19) United States
(12) Patent Application Publication
(10) Pub. No.: US 2018/0327611 A1
(43) Pub. Date: Nov. 15, 2018

(54) CONDUCTIVE COMPOSITIONS

(71) Applicant: VORBECK MATERIAL CORP., Jessup, MD (US)

(72) Inventors: DAN F. SCHEFFER, FREDERICK, MD (US); KENNETH E. FRITSCH, ARNOLD, MD (US)

(73) Assignee: VORBECK MATERIALS CORP., JESSUP, MD (US)

(21) Appl. No.: 14/812,920

(22) Filed: Jul. 29, 2015

Related U.S. Application Data
(60) Provisional application No. 62/031,146, filed on Jul. 30, 2014.

(51) Int. Cl. C09D 5/24; C09D 7/61; C09D 11/52; C09D 11/38

(52) U.S. Cl. CPC C09D 5/24; C09D 7/61; C09D 201/00; C09D 11/38; C09D 11/52

(57) ABSTRACT

Embodiments of the present invention relate to a conductive composition, an ink or coating, and an article. The conductive composition comprises graphene sheets, graphite, and carbon black. A conductive ink or coating comprising graphene sheets, graphite, and carbon black.

### CROSS-REFERENCE TO RELATED APPLICATIONS

This application claims priority to U.S. Provisional Application No. 62/031,146 filed Jul. 30, 2014. The application is hereby incorporated herein by reference.

### BACKGROUND

The present invention relates generally to conductive compositions and specifically to electrically conductive graphene-based compositions. Electrically conductive compositions are typically comprised of, for example, powered or flaked metals, such as silver and carbon-like materials. Electrically conductive compositions may also be comprised of conductive polymeric material. Such compositions can exhibit high resistance, which may not applicable for certain applications.

### DETAILED DESCRIPTION

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. As used herein, the term “about” refers to a range of ±0.5 for given values greater than or equal to 1 and ±0.05 for values less than 1. Compositions comprising graphene sheets are referred to herein as “filled compositions”. Materials that include the same composition as filled composite, except for the graphene sheets are referred to herein as “unfilled compositions”.

Electrically conductive compositions may typically include, for example, spherical, powered or flaked metals, such as silver and carbon-like materials. Electrically conductive compositions may also be comprised of conductive polymeric material. Such compositions can exhibit high resistance, which may not applicable for certain applications.

Embodiments of the present invention seek to provide a graphene-based composition (hereinafter “the composition”). In certain embodiments, the composition has a reduced surface resistance compared to unfilled compositions. In certain embodiments, the composition is in the form of an ink or coating (hereinafter “the ink or coating”). The composition can also include one or more graphite sheets, polymers and/or conductive carbon materials (discussed below). The graphene sheets may be present relative to the graphite and carbon black from about 0.2 to about 10, about 0.2 to about 8, about 0.2 to about 6, about 0.2 to about 5, about 0.2 to about 4, about 0.2 to about 3, about 0.2 to about 2.5, about 0.2 to about 2, about 0.2 to about 1, about 0.5 to about 10, about 0.5 to about 8, about 0.5 to about 6, about 0.5 to about 5, about 0.5 to about 4, about 0.5 to about 3, about 0.5 to about 2.5, about 0.5 to about 2, about 0.5 to about 1, 1 to about 10, about 1 to about 8, about 1 to about 6, about 1 to about 5, about 1 to about 4, about 1 to about 3, about 1 to about 2.5, or about 1 to about 2.

In some embodiments, the surface resistivity of the composition may be no greater than about 10000 Ω/square/mil, or no greater than about 5000 Ω/square/mil, or no greater than about 1000 Ω/square/mil or no greater than about 700 Ω/square/mil, or no greater than about 500 Ω/square/mil, or no greater than about 350 Ω/square/mil, or no greater than about 200 Ω/square/mil, or no greater than about 200 Ω/square/mil, or no greater than about 150 Ω/square/mil, or no greater than about 100 Ω/square/mil, or no greater than about 75 Ω/square/mil, or no greater than about 50 Ω/square/mil, or no greater than about 30 Ω/square/mil, or no greater than about 20 Ω/square/mil, or no greater than about 10 Ω/square/mil, or no greater than about 5 Ω/square/mil, or no greater than about 1 Ω/square/mil, or no greater than about 0.1 Ω/square/mil, or no greater than about 0.01 Ω/square/mil, or no greater than about 0.001 Ω/square/mil. In certain embodiments, the composition has a surface resistance of about 0.1 to about 50 Ω/square/mil.

In other embodiments, the composition can be electrically and/or thermally conductive. In some embodiments, the composition can have a conductivity of at least about 10⁻⁸ S/m. The composition can have a conductivity of about 10⁻⁶ S/m to about 10⁵ S/m, or of about 10⁻⁵ S/m to about 10⁵ S/m. In still other embodiments, the composition has conductivities of at least about 0.001 S/m, of at least about 0.01 S/m, of at least about 0.1 S/m, of at least about 1 S/m, of at least about 10 S/m, of at least about 100 S/m, or at least about 1000 S/m, or at least about 10,000 S/m, or at least about 20,000 S/m, or at least about 30,000 S/m, or at least about 40,000 S/m, or at least about 50,000 S/m, or at least about 60,000 S/m, or at least about 75,000 S/m, or at least about 10⁵ S/m, or at least about 10⁶ S/m.

In some cases, the surface resistivity of the composition can be no greater than about 10 mega Ω/square/mil, or no greater than about 1 mega Ω/square/mil, or no greater than about 500 kilo Ω/square/mil, or no greater than about 200 kilo Ω/square/mil, or no greater than about 100 kilo Ω/square/mil, or no greater than about 50 kilo Ω/square/mil, or no greater than about 25 kilo Ω/square/mil, or no greater than about 10 kilo Ω/square/mil, or no greater than about 5 kilo Ω/square/mil, or no greater than about 1000 Ω/square/mil, or no greater than about 700 Ω/square/mil, or no greater than about 500 Ω/square/mil, or no greater than about 350 Ω/square/mil, or no greater than about 200 Ω/square/mil, or no greater than about 200 Ω/square/mil, or no greater than about 150 Ω/square/mil, or no greater than about 100 Ω/square/mil, or no greater than about 75 Ω/square/mil, or no greater than about 50 Ω/square/mil, or no greater than about 30 Ω/square/mil, or no greater than about 20 Ω/square/mil, or no greater than about 10 Ω/square/mil, or no greater than about 5 Ω/square/mil, or no greater than about 1 Ω/square/mil, or no greater than about 0.1 Ω/square/mil, or no greater than about 0.01 Ω/square/mil, or no greater than about 0.001 Ω/square/mil.

In some cases, the composition can have a thermal conductivity of about 0.1 to about 50 W/m·K, or of about 0.5 to about 30 W/m·K, or of about 0.1 to about 0.5 W/m·K, or of about 0.1 to about 1 W/m·K, or of about 0.1 to about 5 W/m·K, or of about 0.5 to about 2 W/m·K, or of about 1 to about 5 W/m·K, or of about 0.1 to about 0.5 W/m·K, or of about 0.1 to about 50 W/m·K, or of about 1 to about 30 W/m·K, or of about 1 to about 20 W/m·K, or of about 1 to about 10 W/m·K, or of about 1 to about 5 W/m·K, or of about 2 to about 25 W/m·K, or of about 5 to about 25 W/m·K, or of at least about 0.7 W/m·K, or of at least 1 W/m·K, or of at least 1.5 W/m·K, or of at least 3 W/m·K, or of at least 5 W/m·K, or of at least 7 W/m·K, or of at least 10 W/m·K, or of at least 15 W/m·K.

The graphene sheets can have a surface area of about 100 to about 2630 m²/g. The graphene sheets typically have a “platey” (e.g. two-dimensional) structure that is distinct from carbon nanotubes, which are typically needle-like forms of carbon nanotubes. The two longest dimensions of the graphene sheets may each be at least about 10 times greater, about 50 times greater, about 100 times greater, about 1000 times greater, about 5000 times greater, or about 10,000 times greater than the shortest dimension (i.e. thickness) of the sheets. In some embodiments, the graphene material also comprises fully exfoliated single sheets of graphite (these are approximately <1 nm thick and are often referred to as “graphene”), or partially exfoliated graphite sheets, wherein two or more sheets of graphite are not exfoliated from each other. The graphene material may comprise mixtures of fully and partially exfoliated graphite sheets.

The graphene sheets may be obtained from, for example, graphite, graphite oxide, expandable graphite, expanded graphite. The graphene sheets may be obtained by the physical exfoliation of graphite by, for example, peeling, grinding, or milling off graphene sheets. The graphene sheets may be made from inorganic precursors, such as silicon carbide. The graphene sheets may be made by chemical vapor deposition (such as by reacting a methane and hydrogen on a metal surface).

The graphene sheets may be made by the reduction of an alcohol, such ethanol, with a metal (such as an alkali metal like sodium) and the subsequent pyrolysis of the alkoxide product, such as disclosed in Nature Nanotechnology (2009), 4, 30-33, herein incorporated by reference. The graphene sheets may be made by the exfoliation of graphite in dispersions or exfoliation of graphite oxide in dispersions and the subsequently reducing the exfoliated graphite oxide. The graphene sheets may be made by the exfoliation of expandable graphite, followed by intercalation, and ultrasonication or other means of separating the intercalated sheets as described in Nature Nanotechnology (2008), 3, 538-542, herein incorporated by reference. The graphene sheets may be made by the intercalation of graphite and the subsequent exfoliation of the product in suspension or thermally. The graphene sheets may comprise mixtures of fully and partially exfoliated graphite sheets.

The graphene sheets may be made from graphite oxide (also known as graphitic acid or graphene oxide). For example, graphite may be treated with oxidizing and/or intercalating agents and exfoliated. The graphite may also be treated with intercalating agents and electrochemically oxidized and exfoliated. The graphene sheets may be formed by ultrasonically exfoliating suspensions of graphite and/or graphite oxide in a liquid (which may contain surfactants and/or intercalants). Exfoliated graphite oxide dispersions or suspensions can be subsequently reduced to graphene sheets. The graphene sheets may also be formed by mechanical treatment, such as grinding or milling, to exfoliate graphite or graphite oxide, which may subsequently be reduced to graphene sheets.

Reduction of graphite oxide to graphene may be accomplished by means of a chemical reduction, which may be carried out on graphite oxide in a dry form or in a dispersion. Examples of useful chemical reducing agents include, but are not limited to, hydrazines, such as hydrazine, N,N-dimethylhydrazine, sodium borohydride, citric acid, hydroquinone, isocyanates, such as phenyl isocyanate, hydrogen, and hydrogen plasma. A dispersion or suspension of exfoliated graphite oxide in a carrier, such as water, organic solvents, or a mixture of solvents, can be made using any suitable method, such as ultrasonication and/or mechanical grinding or milling, and reduced to graphene sheets, in accordance with an embodiment of the present invention.

Graphite oxide may be produced by any method known in the art, in accordance with an embodiment of the present invention. For example, graphite oxide can result from the oxidation of graphite using one or more chemical oxidizing agents and, optionally, intercalating agents such as sulfuric acid. Examples of applicable oxidizing agents include, but are not limited to, nitric acid, nitrates, such as sodium and potassium nitrates, perchlorates, potassium chlorate, sodium chlorate, chromic acid, potassium chromate, sodium chromate, potassium dichromate, sodium dichromate, hydrogen peroxide, sodium and potassium permanganates, phosphoric acid (H₃PO₄), phosphorus pentoxide, and bisulfites. Applicable oxidants include, but are not limited to, KClO₄; HNO₃ and KClO₃; KMnO₄ and/or NaMnO₄; KMnO₄ and NaNO₃; K₂S₂O₈ and P₂O₅ and KMnO₄; KMnO₄ and HNO₃; and HNO₃. Applicable intercalation agents include sulfuric acid. Graphite may also be treated with intercalating agents and electrochemically oxidized to produce graphite oxide. Examples of applicable methods of making graphite oxide are also described by Staudenmaier (Ber. Stsch. Chem. Ges. (1898), 31, 1481) and Hummers (J. Am. Chem. Soc. (1958), 80, 1339), which are both herein incorporated by reference.

An example of a method for the preparation of graphene sheets involves the oxidation of graphite to graphite oxide, and subsequent thermal exfoliation, as described in US 2007/0092432, which is hereby incorporated by reference. The resulting graphene sheets typically display little or no signature corresponding to graphite or graphite oxide in their X-ray diffraction pattern. The thermal exfoliation may be carried out in a continuous or semi-continuous batch process.

The thermal exfoliation heating can be accomplished in a batch process or a continuous process and can be done under a variety of atmospheres, including inert and reducing atmospheres, such as nitrogen, argon, and/or hydrogen atmospheres. Required heating times can range from under a few seconds or several hours or more, depending on the temperatures used and the characteristics desired in the final thermally exfoliated graphite oxide. The heating can be undertaking in any appropriate vessel, such as a fused silica, mineral, metal, carbon, such as graphite, or ceramic vessel. The heating may be accomplished using a flash lamp or with microwaves. For example, during heating, the graphite oxide may be contained in an essentially constant location in single batch reaction vessel, or may be transported through one or more vessels during the reaction in a continuous or batch mode. The heating may be accomplished using any suitable means, including the use of furnaces and infrared heaters, in accordance with an embodiment of the present invention.

The example, the thermal exfoliation and/or reduction of graphite oxide can be carried out at a temperature of at least 150° C., at least 200° C., at least 300° C., at least 400° C., at least 450° C., at least 500° C., at least 600° C., at least 700° C., at least 750° C., at least 800° C., at least 850° C., at least 900° C., at least 950° C., at least 1000° C., at least 1100° C., at least 1500° C., at least 2000° C., and at least 2500° C. Applicable temperature ranges required for the thermal exfoliation and/or reduction include between about 750 about and 3000° C., between about 850 and 2500° C., between about 950 and about 2500° C., between about 950 and about 1500° C., between about 750 about and 3100° C., between about 850 and 2500° C., or between about 950 and about 2500° C.

The time of heating can range from less than a second to a plurality of minutes, for example, less than 0.5 seconds, less than 1 second, less than 5 seconds, less than 10 seconds, less than 20 seconds, less than 30 seconds, or less than 1 min. The time of heating can be at least 1 minute, at least 2 minutes, at least 5 minutes, at least 15 minutes, at least 30 minutes, at least 45 minutes, at least 60 minutes, at least 90 minutes, at least 120 minutes, at least 150 minutes, at least 240 minutes, from 0.01 seconds to 240 minutes, from 0.5 seconds to 240 minutes, from 1 second to 240 minutes, from 1 minute to 240 minutes, from 0.01 seconds to 60 minutes, from 0.5 seconds to 60 minutes, from 1 second to 60 minutes, from 1 minute to 60 minutes, from 0.01 seconds to 10 minutes, from 0.5 seconds to 10 minutes, from 1 second to 10 minutes, from 1 minute to 10 minutes, from 0.01 seconds to 1 minute, from 0.5 seconds to 1 minute, from 1 second to 1 minute, no more than 600 minutes, no more than 450 minutes, no more than 300 minutes, no more than 180 minutes, no more than 120 minutes, no more than 90 minutes, no more than 60 minutes, no more than 30 minutes, no more than 15 minutes, no more than 10 minutes, no more than 5 minutes, no more than 1 minute, no more than 30 seconds, no more than 10 seconds, or no more than 1 second. During the course of heating, the temperature may vary.

Examples of the rate of heating can include at least 120° C./min, at least 200° C./min, at least 300° C./min, at least 400° C./min, at least 600° C./min, at least 800° C./min, at least 1000° C./min, at least 1200° C./min, at least 1500° C./min, at least 1800° C./min, and at least 2000° C./min.

The graphene sheets may be annealed or reduced to graphene sheets having higher carbon to oxygen ratios by heating under reducing atmospheric conditions (e.g., in systems purged with inert gases or hydrogen). The reduction/annealing temperatures can be at least 300° C., or at least 350° C., or at least 400° C., or at least 500° C., or at least 600° C., or at least 750° C., or at least 850° C., or at least 950° C., or at least 1000° C. The reduction/annealing temperature used may be, for example, between about 750 about and 3000° C., or between about 850 and 2500° C., or between about 950 and about 2500° C.

The time of heating for the reduction/annealing can be for example, at least 1 second, or at least 10 second, or at least 1 minute, or at least 2 minutes, or at least 5 minutes. In some embodiments, the heating time for the reduction/annealing is at least 15 minutes, or 30 minutes, or 45 minutes, or 60 minutes, or 90 minutes, or 120 minutes, or 150 minutes. During the course of annealing/reduction, the temperature may vary within these ranges.

The heating may be done under a variety of conditions, including in an inert atmosphere, such as argon or nitrogen, or a reducing atmosphere, such as hydrogen, including, but not limited to, hydrogen diluted in an inert gas such as argon or nitrogen, or under vacuum. The heating may be done in any appropriate vessel, such as a fused silica or a mineral or ceramic vessel or a metal vessel. The heated materials, including any starting materials and any products or intermediates may be contained in an essentially constant location in single batch reaction vessel, or may be transported through one or more vessels during the reaction in a continuous or batch reaction. Heating may be done using any suitable means, including the use of furnaces and infrared heaters.

The graphene sheets can have a surface area of at least 100 m²/g to for example, at least 200 m²/g, at least 300 m²/g, at least 350 m²/g, at least 400 m²/g, at least 500 m²/g, at least 600 m²/g, at least 700 m²/g, at least 800 m²/g, at least 900 m²/g, or at least 700 m²/g. The surface area may be 400 to 1100 m²/g. The maximum surface area can be calculated to be 2630 m²/g. The surface area can include all values and subvalues therebetween, including, for example, 400, 500, 600, 700, 800, 900, 1000, 1100, 1200, 1300, 1400, 1500, 1600, 1700, 1800, 1900, 2000, 2100, 2200, 2300, 2400, 2500, and 2630 m²/g.

The graphene sheets can have number average aspect ratios of 100 to 100,000, or of 100 to 50,000, or of 100 to 25,000, or of 100 to 10,000. The aspect ratio is the ratio of the longest dimension of the sheet to the shortest.

The graphene sheets may have a bulk density of about 0.01 to at least about 200 kg/m³. The bulk density can include all values and subvalues therebetween, including 0.05, 0.1, 0.5, 1, 5, 10, 15, 20, 25, 30, 35, 50, 75, 100, 125, 150, and 175 kg/m³.

The graphene sheets may be functionalized with, for example, oxygen-containing functional groups (including, but not limited to, hydroxyl, carboxyl, and epoxy groups) and typically have an overall carbon to oxygen molar ratio (hereinafter “C/O ratio”), as determined by bulk elemental analysis, of at least 1:1, or at least 3:2. Examples of C/O ratio can include 3:2 to 85:15; 3:2 to 20:1; 3:2 to 30:1; 3:2 to 40:1; 3:2 to 60:1; 3:2 to 80:1; 3:2 to 100:1; 3:2 to 200:1; 3:2 to 500:1; 3:2 to 1000:1; 3:2 to greater than 1000:1; 10:1 to 30:1; 80:1 to 100:1; 20:1 to 100:1; 20:1 to 500:1; 20:1 to 1000:1; 50:1 to 300:1; 50:1 to 500:1; and 50:1 to 1000:1. In some embodiments, the C/O ratio is at least 10:1, or at least 15:1, or at least 20:1, or at least 35:1, or at least 50:1, or at least 75:1, or at least 100:1, or at least 200:1, or at least 300:1, or at least 400:1, or at least 500:1, or at least 750:1, or at least 1000:1; or at least 1500:1, or at least 2000:1. The C/O ratio also can include all values and subvalues between these ranges.

The graphene sheets may contain atomic scale kinks, which may be caused by the presence of lattice defects in, or by chemical functionalization of the two-dimensional hexagonal lattice structure of the graphite basal plane.

The graphene sheets may comprise two or more graphene powders having different particle size distributions and/or morphologies. The graphite may also comprise two or more graphite powders having different particle size distributions and/or morphologies.

The graphene sheets, and optionally, additional components can be combined with polymers to make composites, including, but not limited to, polymer composites. The graphene sheets and, optionally, additional components can be dispersed in one or more solvents with or without a polymer binder. As stated above, the compositions may be in the form of ink and coatings (hereinafter “the inks and coatings”). The inks and coatings as used herein can refer to those that are suitable for application to a substrate as well as the material after it is applied to the substrate, while it is being applied to the substrate, and both before and after any post-application treatments, such as evaporation, cross-linking, and curing. The components of the inks and coating compositions may vary during these stages. The inks and coatings may optionally further comprise a polymeric binder.

The graphene sheets and, when present, additional components, can be combined with polymers using any suitable method, including solution/dispersion blending and melt processing using, for example, a single or twin-screw extruder, a blender, a kneader, and a Banbury mixer. The polymers can be used as binders. Applicable polymers include, but are not limited to, thermosets, thermoplastics, and non-melt processible polymers. In an embodiment, polymers can also comprise monomers that can be polymerized before, during, or after the application of the coating to the substrate. Polymeric binders can be crosslinked or otherwise cured after the coating has been applied to the substrate. Examples of applicable polymers include, but are not limited to polyolefins (such as polyethylene, linear low density polyethylene (LLDPE), low density polyethylene (LDPE), high density polyethylene, polypropylene, and olefin copolymers), nitrile butadiene rubbers (NBR), highly saturated nitrile rubbers (HSN), styrene/butadiene rubbers (SBR), styrene/ethylene/butadiene/styrene copolymers (SEBS), butyl rubbers, ethylene/propylene copolymers (EPR), ethylene/propylene/diene monomer copolymers (EPDM), polystyrene (including high impact polystyrene), poly(vinyl acetates), ethylene/vinyl acetate copolymers (EVA), poly(vinyl alcohols), ethylene/vinyl alcohol copolymers (EVOH), poly(vinyl butyral) (PVB), poly(vinyl formal), poly(methyl methacrylate) and other acrylate polymers and copolymers (such as methyl methacrylate polymers, methacrylate copolymers, polymers derived from one or more acrylates, methacrylates, ethyl acrylates, ethyl methacrylates, butyl acrylates, butyl methacrylates, glycidyl acrylates and methacrylates and the like), olefin and styrene copolymers, acrylonitrile/butadiene/styrene (ABS), styrene/acrylonitrile polymers (SAN), styrene/maleic anhydride copolymers, isobutylene/maleic anhydride copolymers, ethylene/acrylic acid copolymers, poly(acrylonitrile), poly(vinyl acetate) and poly(vinyl acetate) copolymers, poly(vinyl pyrrolidone) and poly(vinyl pyrrolidone) copolymers, vinyl acetate and vinyl pyrrolidone copolymers, polycarbonates (PC), polyamides, polyesters, liquid crystalline polymers (LCPs), poly(lactic acid) (PLA), poly(phenylene oxide) (PPO), PPO-polyamide alloys, polysulphone (PSU), polysulfides, polyetherketone (PEK), polyetheretherketone (PEEK), polyimides, polyoxymethylene (POM) homo- and copolymers, polyetherimides, fluorinated ethylene propylene polymers (FEP), poly(vinyl fluoride), poly(vinylidene fluoride), poly(vinylidene chloride), poly(vinyl chloride) (PVC), polyurethanes (thermoplastic and thermosetting (including crosslinked polyurethanes, such as crosslinked amines), aramides (such as Kevlar® and Nomex®), polysulfides, polytetrafluoroethylene (PTFE), polysiloxanes (including, but not limited to, polydimethylenesiloxane, dimethylsiloxane/vinylmethylsiloxane copolymers, and vinyldimethylsiloxane terminated poly(dimethylsiloxane)), elastomers, epoxy polymers (including, but not limited to, crosslinked epoxy polymers, such as those crosslinked with polysulfones and amines), polyureas, alkyds, cellulosic polymers (such as nitrocellulose, ethyl cellulose, ethyl hydroxyethyl cellulose, carboxymethyl cellulose, cellulose acetate, cellulose acetate propionates, and cellulose acetate butyrates), polyethers (such as poly(ethylene oxide), poly(propylene oxide), poly(propylene glycol), and oxide/propylene oxide copolymers), acrylic latex polymers, polyester acrylate oligomers and polymers, polyester diol diacrylate polymers, and UV-curable resins.

Examples of applicable elastomers include, but are not limited to, polyurethanes, copolyetheresters, rubbers (including butyl rubbers and natural rubbers), styrene/butadiene copolymers, styrene/ethylene/butadiene/styrene copolymer (SEBS), polyisoprene, ethylene/propylene copolymers (EPR), ethylene/propylene/diene monomer copolymers (EPDM), polysiloxanes, and polyethers (such as poly(ethylene oxide), poly(propylene oxide), and their copolymers).

Examples of applicable polyamides include, but are not limited to, aliphatic polyamides, such as polyamide 4,6; polyamide 6,6; polyamide 6; polyamide 11; polyamide 12; polyamide 6,9; polyamide 6,10; polyamide 6,12; polyamide 10,10; polyamide 10,12; and polyamide 12,12), alicyclic polyamides, and aromatic polyamides (such as poly(m-xylylene adipamide) (polyamide MXD,6)) and polyterephthalamides such as poly(dodecamethylene terephthalamide) (polyamide 12,T), poly(decamethylene terephthalamide) (polyamide 10,T), poly(nonamethylene terephthalamide) (polyamide 9,T), the polyamide of hexamethylene terephthalamide and hexamethylene adipamide, the polyamide of hexamethyleneterephthalamide, and 2-methylpentamethyleneterephthalamide. The polyamides may be polymers and copolymers (i.e., polyamides having at least two different repeat units) having melting points between 120 and 255° C. including, but not limited to, aliphatic copolyamides having a melting point of 230° C. or less, aliphatic copolyamides having a melting point of 210° C. or less, aliphatic copolyamides having a melting point of 200° C. or less, and aliphatic copolyamides having a melting point of 180° C. or less, for example Macromelt® and Versamid®.

Examples of acrylate polymers may include, but are not limited to, those made by the polymerization of one or more acrylic acids (including acrylic acid and methacrylic acid) and their derivatives, such as esters. Other examples of acrylate polymers may include methyl acrylate polymers, methyl methacrylate polymers, and methacrylate copolymers. Additional examples of acrylate polymers may include polymers derived from one or more acrylates, methacrylates, acrylic acid, methacrylic acid, methyl acrylate, methyl methacrylate, ethyl acrylate, ethyl methacrylate, butyl acrylate, butyl methacrylate, glycidyl acrylate, glycidyl methacrylates, 2-ethylhexyl acrylate, 2-ethylhexyl methacrylate, hydroxyethyl acrylate, hydroxyethyl (meth)acrylate, acrylonitrile, and the like. The polymers may comprise repeat units derived from other monomers such as olefins (e.g. ethylene and propylene), vinyl acetates, vinyl alcohols, and vinyl pyrrolidones. Still other examples of acrylate polymers may include partially neutralized acrylate polymers and copolymers (such as ionomer resins).

Examples of applicable polymers can further include Elvacite® polymers supplied by Lucite International, Inc., including Elvacite® 2009, 2010, 2013, 2014, 2016, 2028, 2042, 2045, 2046, 2550, 2552,2614, 2669, 2697, 2776, 2823, 2895, 2927, 3001, 3003, 3004, 4018, 4021, 4026, 4028, 4044, 4059, 4400, 4075, 4060, and 4102. Other polymer families include Bynel® polymers, such as Bynel® 2022 and Joncryl® polymers, such as Joncryl® 678 and 682.

The composition can comprise a ratio by weight of graphite, carbon black, and graphene sheets to polymer of about 2:98 to 98:2, about 5:95 to about 98:2, about 10:90 to about 98:2, about 20:80 to about 98:2, about 30:70 to about 98:2, 40:60 to about 98:2, about 50:50 to about 98:2, about 60:40 to about 98:2, about 70:30 to about 98:2, about 80:20 to about 98:2, about 90:10 to about 98:2, about 95:5 to about 98:2, 2:98 to 95:2, about 5:95 to about 95:2, about 10:90 to about 95:2, about 20:80 to about 95:2, about 30:70 to about 95:2, 40:60 to about 95:2, about 50:50 to about 95:2, about 60:40 to about 95:2, about 70:30 to about 95:2, about 80:20 to about 95:2, about 90:10 to about 95:2, about 95:5 to about 95:2, 2:98 to 90:10, about 5:95 to about 90:10, about 10:90 to about 90:10, about 20:80 to about 90:10, about 30:70 to about 90:10, 40:60 to about 90:10, about 50:50 to about 90:10, about 60:40 to about 90:10, about 70:30 to about 90:10, about 80:20 to about 90:10, about 90:10 to about 90:10, about 95:5 to about 90:10, 2:98 to 80:20, about 5:95 to about 80:20, about 10:90 to about 80:20, about 20:80 to about 80:20, about 30:70 to about 80:20, 40:60 to about 80:20, about 50:50 to about 80:20, about 60:40 to about 80:20, about 70:30 to about 80:20, about 80:20 to about 80:20, about 90:10 to about 80:20, about 95:5 to about 80:20, 2:98 to 70:30, about 5:95 to about 70:30, about 10:90 to about 70:30, about 20:80 to about 70:30, about 30:70 to about 70:30, 40:60 to about 70:30, about 50:50 to about 70:30, about 60:40 to about 70:30, about 70:30 to about 70:30, about 80:20 to about 70:30, about 90:10 to about 70:30, about 95:5 to about 70:30, 2:98 to 60:40, about 5:95 to about 60:40, about 10:90 to about 60:40, about 20:80 to about 60:40, about 30:70 to about 60:40, 40:60 to about 60:40, about 50:50 to about 60:40, about 60:40 to about 60:40, about 70:30 to about 60:40, about 80:20 to about 60:40, about 90:10 to about 60:40, about 95:5 to about 60:40, 2:98 to 50:50, about 5:95 to about 50:50, about 10:90 to about 50:50, about 20:80 to about 50:50, about 30:70 to about 50:50, 40:60 to about 50:50, about 50:50 to about 50:50, about 60:40 to about 50:50, about 70:30 to about 50:50, about 80:20 to about 50:50, about 90:10 to about 50:50, about 95:5 to about 50:50, 2:98 to 40:60, about 5:95 to about 40:60, about 10:90 to about 40:60, about 20:80 to about 40:60, about 30:70 to about 40:60, 40:60 to about 40:60, about 50:50 to about 40:60, about 60:40 to about 40:60, about 70:30 to about 40:60, about 80:20 to about 40:60, about 90:10 to about 40:60, about 95:5 to about 40:60, 2:98 to 30:70, about 5:95 to about 30:70, about 10:90 to about 30:70, about 20:80 to about 30:70, about 30:70 to about 30:70, 40:60 to about 30:70, about 50:50 to about 30:70, about 60:40 to about 30:70, about 70:30 to about 30:70, about 80:20 to about 30:70, about 90:10 to about 30:70, about 95:5 to about 30:70, 2:98 to 20:80, about 5:95 to about 20:80, about 10:90 to about 20:80, about 20:80 to about 20:80, about 30:70 to about 20:80, 40:60 to about 20:80, about 50:50 to about 20:80, about 60:40 to about 20:80, about 70:30 to about 20:80, about 80:20 to about 20:80, about 90:10 to about 20:80, about 95:5 to about 20:80, 2:98 to 10:90, about 5:95 to about 10:90, about 10:90 to about 10:90, about 20:80 to about 10:90, about 30:70 to about 10:90, 40:60 to about 10:90, about 50:50 to about 10:90, about 60:40 to about 10:90, about 70:30 to about 10:90, about 80:20 to about 10:90, about 90:10 to about 10:90, about 95:5 to about 10:90, 2:98 to 5:95, about 5:95 to about 5:95, about 10:90 to about 5:95, about 20:80 to about 5:95, about 30:70 to about 5:95, 40:60 to about 5:95, about 50:50 to about 5:95, about 60:40 to about 5:95, about 70:30 to about 5:95, about 80:20 to about 5:95, about 90:10 to about 5:95, about 95:5 to about 5:95.

Examples of applicable polyesters include, but are not limited to, poly(butylene terephthalate) (PBT), poly(ethylene terephthalate) (PET), poly(1,3-propylene terephthalate) (PPT), poly(ethylene naphthalate) (PEN), and poly(cyclohexanedimethanol terephthalate) (PCT). In some embodiments, the polymer has an acid number of at least 5, or at least 10, or at least 15, or at least 20.

In certain embodiments, the glass transition temperature of at least one polymer is no greater than 100° C., 90° C., or no greater than 80° C., or no greater than 70° C., or no greater than 60° C., or no greater than 50° C., or no greater than 40° C.

In other embodiments, a binder can be present relative to graphene sheets and graphite, when used, from 1 to 99 weight percent, or from 1 to 50 weight percent, or from 1 to 30 weight percent, or from 1 to 20 weight percent, or from 5 to 80 weight percent, or from 5 to 60 weight percent, or from 5 to 30 weight percent, or from 15 to 85 weight percent, or from 15 to 60 weight percent, or from 15 to 30 weight percent, or from 25 to 80 weight percent, or from 25 to 50 weight percent, or from 40 to 90 weight percent, or from 50 to 90 weight percent, or from 70 to 95 weight percent, based on the total weight of binder and graphene plus graphite, when present. In still other embodiments, the graphene sheets are present in about 0.2 to about 10, 0.2 to about 5, or about 0.2 to about 3 weight percent relative to the total weight of graphene sheets, graphite, and carbon black

Examples of applicable solvents into which the graphene sheets and aromatic compounds can be dispersed include water, distilled or synthetic isoparaffinic hydrocarbons, such as Isopar® and Norpar® and Dowanol®, citrus terpenes and mixtures containing citrus terpenes, such as Purogen®, Electron, and Positron, terpenes and terpene alcohols (including terpineols, including alpha-terpineol), limonene, aliphatic petroleum distillates, alcohols (such as methanol, ethanol, n-propanol, i-propanol, n-butanol, i-butanol, sec-butanol, tert-butanol, pentanols, i-amyl alcohol, hexanols, heptanols, octanols, diacetone alcohol, butyl glycol, etc.), ketones (such as acetone, methyl ethyl ketone, cyclohexanone, i-butyl ketone, 2,6,8,trimethyl-4-nonanone etc.), esters (such as methyl acetate, ethyl acetate, n-propyl acetate, i-propyl acetate, n-butyl acetate, i-butyl acetate, tert-butyl acetate, carbitol acetate), glycol ethers, ester and alcohols (such as 2-(2-ethoxyethoxy)ethanol, propylene glycol monomethyl ether and other propylene glycol ethers; ethylene glycol monobutyl ether, 2-methoxyethyl ether (diglyme), propylene glycol methyl ether (PGME); and other ethylene glycol ethers; ethylene and propylene glycol ether acetates, diethylene glycol monoethyl ether acetate, 1-methoxy-2-propanol acetate (PGMEA); and hexylene glycol, such as Hexasol™, dibasic esters (such as dimethyl succinate, dimethyl glutarate, dimethyl adipate), dimethylsulfoxide (DMSO), 1,3-dimethyl-3,4,5,6-tetrahydro-2(1H)-pyrimidinone (DMPU), imides, amides (such as dimethylformamide (DMF) and dimethylacetamide), cyclic amides (such as N-methylpyrrolidone and 2-pyrrolidone), lactones (such as beta-propiolactone, gamma-valerolactone, delta-valerolactone, gamma-butyrolactone, epsilon-caprolactone), cyclic imides (such as imidazolidinones such as N,N′-dimethylimidazolidinone (1,3-dimethyl-2-imidazolidinone)), aromatic solvents and aromatic solvent mixtures (such as toluene, xylenes, mesitylene, and cumene), petroleum distillates, naphthas (such as VM&P naphtha), and mixtures of two or more of the foregoing and mixtures of one or more of the foregoing with other carriers. Solvents can be, for example, low- or non-VOC solvents, non-hazardous air pollution solvents, and non-halogenated solvents.

The compositions can contain additives such as dispersion aids (including surfactants, emulsifiers, and wetting aids), adhesion promoters, thickening agents (including clays), defoamers and antifoamers, biocides, additional fillers, flow enhancers, stabilizers, crosslinking and curing agents, as well as conductive additives.

Examples of applicable dispersing aids include glycol ethers (such as poly(ethylene oxide), block copolymers derived from ethylene oxide and propylene oxide, such Pluronic®), acetylenic diols (such as 2,5,8,11-tetramethyl-6-dodecyn-5,8-diol ethoxylate and Surfynol® and Dynol®, salts of carboxylic acids (including alkali metal and ammonium salts), and polysiloxanes.

Examples of applicable grinding aids include stearates (such as Al, Ca, Mg, and Zn stearates) and acetylenic diols, such as Surfynol® and Dynol®).

Examples of applicable adhesion promoters include titanium chelates and other titanium compounds such as titanium phosphate complexes (including butyl titanium phosphate), titanate esters, diisopropoxy titanium bis(ethyl-3-oxobutanoate, isopropoxy titanium acetylacetonate, and Vertec.

The compositions may optionally comprise at least one “multi-chain lipid”, by which term is meant a naturally-occurring or synthetic lipid having a polar head group and at least two nonpolar tail groups connected thereto. Examples of applicable polar head groups include, but are not limited to, oxygen-, sulfur-, and halogen-containing, phosphates, amides, ammonium groups, amino acids (including α-amino acids), saccharides, polysaccharides, esters (Including glyceryl esters), and zwitterionic groups.

The tail groups may be the same or different. Applicable tail groups include, but are not limited to, alkanes, alkenes, alkynes, and aromatic compounds. The tail groups may be hydrocarbons, functionalized hydrocarbons. The tail groups may be saturated or unsaturated. The tail groups may be linear or branched. The tail groups may be derived from, for example, fatty acids, such as oleic acid, palmitic acid, stearic acid, arachidic acid, erucic acid, arachadonic acid, linoleic acid, linolenic acid, and oleic acid.

Applicable multi-chain lipids include, but are not limited to, lecithin and other phospholipids (such as phosphatidylcholine, phosphoglycerides (including phosphatidylserine, phosphatidylinositol, phosphatidylethanolamine (cephalin), and phosphatidylglycerol) and sphingomyelin); glycolipids (such as glucosyl-cerebroside); saccharolipids; and sphingolipids (such as ceramides, di- and triglycerides, phosphosphingolipids, and glycosphingolipids). The multi-chain lipids may be amphoteric, including zwitterionic.

Examples of thickening agents include, but are not limited to, glycol ethers (such as poly(ethylene oxide), block copolymers derived from ethylene oxide and propylene oxide (such as Pluronic®), long-chain carboxylate salts (such aluminum, calcium, zinc, etc. salts of stearates, oleats, and palmitates), aluminosilicates (such as Minex® and Aerosil® 9200), fumed silica, natural and synthetic zeolites.

Examples of applicable electrically conductive polymers include, but are not limited to, polyacetylene, polyethylene dioxythiophene (PEDOT), poly(styrenesulfonate) (PSS), PEDOT:PSS copolymers, polythiophene and polythiophenes, poly(3-alkylthiophenes), poly(2,5-bis(3-tetradecylthiophen-2-yl)thieno[3,2-b]thiophene) (PBTTT), poly(phenylenevinylene), polypyrene, polycarbazole, polyazulene, polyazepine, polyflurorenes, polynaphthalene, polyisonaphthalene, polyaniline, polypyrrole, poly(phenylene sulfide), polycarbozoles, polyindoles, polyphenylenes, copolymers of one or more of the foregoing, and their derivatives and copolymers. The conductive polymers may be undoped or doped, for example, with boron, phosphorous, and iodine.

Applicable conductive carbons include, but are not limited to, graphite (including natural, Kish, and synthetic, annealed, pyrolytic, highly oriented pyrolytic, and graphites), graphitized carbon, mesoporous carbon, carbon fibers and fibrils, carbon whiskers, vapor-grown carbon nanofibers, metal coated carbon fibers, carbon nanotubes (including single- and multi-walled nanotubes), fullerenes, activated carbon, carbon fibers, expanded graphite, expandable graphite, graphite oxide, hollow carbon spheres, and carbon foams. Applicable carbon black material includes conductive carbon black material that may be of a very high purity. The carbon black material may be in a soft pellet and/or powder form. Applicable carbon black materials include, but are not limited to, Ketjen EC-600®, Emperor® 1600, 1200, and 1800, Ensaco 250G, 350G, 260G, as well as various American Society for Testing and Materials (ASTM) grade (such as N110, N115, N120, N121, N125, N134, N135, S212, N220, N231, N234, N239, N299, S315, N326, N330, N335, N339, N343, N347, N351, N356, N358, N357, N539, N550, N582, N630, N642, N650, N660, N683, N754, N762, N765, N772N774, N787, N907, N908, N990, and N991).

Inks and coatings can be formed by blending the composition with at least one solvent and/or binder, and, optionally, other additives. Such blending can be done using one or more of the preceding methods. The composition may be made using any suitable method, including wet or dry methods and batch, semi-continuous, and continuous methods, in accordance with an embodiment of the present invention. Dispersions, suspensions, solutions, etc. of graphene sheets and one or more aromatic compounds (including inks and coatings formulations) can be made or processed (e.g., milled/ground, blended, dispersed, and suspended) by using suitable mixing, dispersing, and/or compounding techniques.

For example, components of the composition, such as one or more of the graphene sheets, carbon black, graphite, binders, carriers, and/or other components can be processed (e.g., milled/ground, blended by using suitable mixing, dispersing, and/or compounding techniques and apparatus, including ultrasonic devices, high-shear mixers, ball mills, attrition equipment, sandmills, two-roll mills, three-roll mills, cryogenic grinding crushers, extruders, kneaders, double planetary mixers, triple planetary mixers, high pressure homogenizers, horizontal and vertical wet grinding mills), accordance with an embodiment of the present invention. Applicable processing (including grinding) technologies can be wet or dry and can be continuous or discontinuous. Suitable materials for use as grinding media include, but are not limited to, metals, carbon steel, stainless steel, ceramics, stabilized ceramic media (such as cerium yttrium stabilized zirconium oxide), PTFE, glass, and tungsten carbide. The aforementioned methods can be used to change the particle size and/or morphology of the graphite, graphene sheets, other components, and blends or two or more components.

Components may be processed together or separately and may go through multiple processing (including mixing/blending) stages, each involving one or more components (including blends).

There are no particular limitations to the manner in which the graphene sheets, graphite, and carbon black and other components may be processed and combined. For example, graphene sheets, carbon black, and/or graphite may be processed into given particle size distributions and/or morphologies separately and then combined for further processing with or without the presence of additional components. Unprocessed graphene sheets, carbon black and/or graphite may be combined with processed graphene sheets, carbon black and/or graphite and further processed with or without the presence of additional components. Processed and/or unprocessed graphene sheets and/or processed and/or unprocessed graphite and/or processed and/or unprocessed carbon black may be combined with other components, such as one or more binders and then combined with processed and/or unprocessed graphene sheets and/or processed and/or unprocessed graphite and/or processed and/or unprocessed carbon black. Two or more combinations of processed and/or unprocessed graphene sheets and/or processed and/or unprocessed carbon black and/or processed and/or unprocessed graphite that have been combined with other components may be further combined or processed. Any of the foregoing processing steps can be done in the presence of at least one aromatic compound.

In one embodiment, if a multi-chain lipid is used, it can be added to graphene sheets (and/or graphite if present) before processing.

After blending and/or grinding steps, additional components may be added to the compositions, including, but not limited to, thickeners, viscosity modifiers, and binders. The compositions may also be diluted by the addition of more carrier. The graphene sheets, carbon black, graphite, and polymer (if present), can be present in the composition in about 0.01 to about 50 weight percent, or about 0.5 to about 50 weight percent, or about 1 to about 50 weight percent, or about 2 to about 50 weight percent, or about 3 to about 50 weight percent, or about 4 to about 50 weight percent, or about 5 to about 50 weight percent, or about 6 to about 50 weight percent, 0.01 to about 40 weight percent, or about 0.5 to about 40 weight percent, or about 1 to about 40 weight percent, or about 2 to about 40 weight percent, or about 3 to about 40 weight percent, or about 4 to about 40 weight percent, or about 5 to about 40 weight percent, or about 6 to about 40 weight percent, 0.01 to about 30 weight percent, or about 0.5 to about 30 weight percent, or about 1 to about 30 weight percent, or about 2 to about 30 weight percent, or about 3 to about 30 weight percent, or about 4 to about 30 weight percent, or about 5 to about 30 weight percent, or about 6 to about 30 weight percent, or about 0.01 to about 20 weight percent, or about 0.1 to about 20 weight percent, or about 0.5 to about 20 weight percent, or about 1 to about 20 weight percent, or about 2 to about 20 weight percent, or about 3 to about 20 weight percent, or about 4 to about 20 weight percent, or about 5 to about 20 weight percent, or about 6 to about 20 weight percent, or about 0.01 to about 15 weight percent, or about 0.1 to about 15 weight percent, or about 0.5 to about 15 weight percent, or about 1 to about 15 weight percent, or about 2 to about 15 weight percent, or about 3 to about 15 weight percent, or about 4 to about 15 weight percent, or about 5 to about 15 weight percent, or about 6 to about 15 weight percent, or about 0.01 to about 10 weight percent, or about 0.1 to about 10 weight percent, or about 0.5 to about 10 weight percent, or about 1 to about 10 weight percent, or about 2 to about 10 weight percent, or about 3 to about 10 weight percent, or about 4 to about 10 weight percent, or about 5 to about 10 weight percent, or about 6 to about 10 weight percent, or about 0.01 to about 8 weight percent, or about 0.1 to about 8 weight percent, or about 0.5 to about 8 weight percent, or about 1 to about 8 weight percent, or about 2 to about 8 weight percent, or about 3 to about 8 weight percent, or about 4 to about 8 weight percent, or about 5 to about 8 weight percent, or about 6 to about 8 weight percent, or about 0.01 to about 6 weight percent, or about 0.1 to about 6 weight percent, or about 0.5 to about 6 weight percent, or about 1 to about 6 weight percent, or about 2 to about 6 weight percent, or about 3 to about 6 weight percent, or about 4 to about 6 weight percent, or about 5 to about 6 weight percent, or about 0.01 to about 4 weight percent, or about 0.1 to about 4 weight percent, or about 0.5 to about 4 weight percent, or about 1 to about 4 weight percent, or about 2 to about 4 weight percent, or about 3 to about 4 weight percent, or about 0.01 to about 3 weight percent, or about 0.1 to about 3 weight percent, or about 0.5 to about 3 weight percent, or about 1 to about 3 weight percent, or about 2 to about 3 weight percent, or about 0.01 to about 2 weight percent, or about 0.1 to about 2 weight percent, or about 0.5 to about 2 weight percent, or about 1 to about 2 weight percent, or about 0.01 to about 1 weight percent, or about 0.1 to about 1 weight percent, or about 0.5 to about 1 weight percent, based on the total weight of the graphene sheets, carbon black, graphite, and polymer (if present).

As inks and coatings, the composition can be applied to a wide variety of applicable substrates, including, but not limited to, flexible and/or stretchable materials, silicones and other elastomers and other polymeric materials, metals (such as aluminum, copper, steel, stainless steel, etc.), adhesives, heat-sealable materials (such as cellulose, biaxially oriented polypropylene (BOPP), poly(lactic acid), polyurethanes, etc.), fabrics (including cloths) and textiles (such as cotton, wool, polyesters, rayon, etc.), clothing, ceramics, silicon surfaces, wood, paper, cardboard, paperboard, cellulose-based materials, glassine, labels, silicon, laminates, corrugated materials, concrete, and brick. The substrates can be in the form of films, papers, and larger three-dimensional objects.

The substrates may have been treated with other coatings (such as paints) or similar materials before the coatings are applied. Examples include, but are not limited to, substrates (such as PET) coated with indium tin oxide, and antimony tin oxide. The substrates may be woven, nonwoven, and in mesh form. The substrates may be woven, nonwoven, and in mesh form.

The substrates may be paper-based materials, including, but are not limited to, paper, paperboard, cardboard, and glassine. The paper-based materials can be surface treated. Examples of applicable surface treatments include, but are not limited to, coatings, such as polymeric coatings, which can include PET, polyethylene, polypropylene, acetates, and nitrocellulose. Coatings may be adhesives. The paper based materials may be sized.

Examples of applicable polymeric materials include, but are not limited to, those comprising thermoplastics and thermosets, including elastomers and rubbers (including thermoplastics and thermosets), silicones, fluorinated polysiloxanes, natural rubber, butyl rubber, chlorosulfonated polyethylene, chlorinated polyethylene, styrene/butadiene copolymers (SBR), styrene/ethylene/butadiene/stryene copolymers (SEBS), styrene/ethylene/butadiene/stryene copolymers grafted with maleic anhydride, styrene/isoprene/styrene copolymers (SIS), polyisoprene, nitrile rubbers, hydrogenated nitrile rubbers, neoprene, ethylene/propylene copolymers (EPR), ethylene/propylene/diene copolymers (EPDM), ethylene/vinyl acetate copolymer (EVA), hexafluoropropylene/vinylidene fluoride/tetrafluoroethylene copolymers, tetrafluoroethylene/propylene copolymers, fluorelastomers, polyesters (such as poly(ethylene terephthalate), poly(butylene terephthalate), poly(ethylene naphthalate), liquid crystalline polyesters, poly(lactic acid)); polystyrene; polyamides (including polyterephthalamides); polyimides (such as Kapton®); aramids (such as Kevlar® and Nomex®); fluoropolymers (such as fluorinated ethylene propylene (FEP), polytetrafluoroethylene (PTFE), poly(vinyl fluoride), poly(vinylidene fluoride)); polyetherimides; poly(vinyl chloride); poly(vinylidene chloride); polyurethanes (such as thermoplastic polyurethanes (TPU); spandex, cellulosic polymers (such as nitrocellulose, cellulose acetate, etc.); styrene/acrylonitriles polymers (SAN); arcrylonitrile/butadiene/styrene polymers (ABS); polycarbonates; polyacrylates; poly(methyl methacrylate); ethylene/vinyl acetate copolymers; thermoset epoxies and polyurethanes; polyolefins (such as polyethylene (including low density polyethylene, high density polyethylene, ultrahigh molecular weight polyethylene, etc.), polypropylene (such as biaxially-oriented polypropylene, etc.); and Mylar. The polymeric materials may be non-woven materials, such as Tyvek®. The polymeric materials may be adhesive or adhesive-backed materials, such as adhesive-backed papers or paper substitutes. The polymeric materials may be mineral-based paper substitutes, such as Teslin®. The substrate may be a transparent or translucent or optical material, such as glass, quartz, polymer (such as polycarbonate or poly(meth)acrylates (such as poly(methyl methacrylate).

The inks and coatings may be applied to the substrate using any suitable method, including, but not limited to, painting, pouring, spin casting, solution casting, dip coating, powder coating, by syringe or pipette, spray coating, curtain coating, lamination, co-extrusion, electrospray deposition, ink jet printing, spin coating, thermal transfer (including laser transfer) methods, doctor blade printing, screen printing, rotary screen printing, gravure printing, lithographic printing, intaglio printing, digital printing, capillary printing, offset printing, electrohydrodynamic (EHD) printing (a method of which is described in WO 2007/053621, which is herein incorporated by reference), microprinting, pad printing, tampon printing, stencil printing, wire rod coating, drawing, flexographic printing, stamping, xerography, microcontact printing, dip pen nanolithography, laser printing, via pen or similar means, in accordance with an embodiment of the present invention. The compositions can be applied in multiple layers.

Subsequent to application to a substrate, the inks and coatings may be cured using any suitable technique, including, but are not limited to, drying and oven-drying (in air or another inert or reactive atmosphere), UV curing, IR curing, drying, crosslinking, thermal curing, laser curing, IR curing, microwave curing or drying, and sintering, in accordance with an embodiment of the present invention.

When cured, the inks and coatings can have a variety of thicknesses, for example, they can optionally have a thickness of at least 2 nm, or at least 5 nm. In various embodiments, the coatings can optionally have a thickness of 2 nm to 2 mm, 5 nm to 1 mm, 2 nm to 100 nm, 2 nm to 200 nm, 2 nm to 500 nm, 2 nm to 1 micrometer, 5 nm to 200 nm, 5 nm to 500 nm, 5 nm to 1 micrometer, 5 nm to 50 micrometers, 5 nm to 200 micrometers, 10 nm to 200 nm, 50 nm to 500 nm, 50 nm to 1 micrometer, 100 nm to 10 micrometers, 1 micrometer to 2 mm, 1 micrometer to 1 mm, 1 micrometer to 500 micrometers, 1 micrometer to 200 micrometers, 1 micrometer to 100 micrometers, 50 micrometers to 1 mm, 100 micrometers to 2 mm, 100 micrometers to 1 mm, 100 micrometers to 750 micrometers, 100 micrometers to 500 micrometers, 500 micrometers to 2 mm, or 500 micrometers to 1 mm.

When applied to a substrate, the inks and coatings can have a variety of forms, including, but not limited to, films or lines, patterns, letters, numbers, circuitry (i.e. printed circuitry), logos, identification tags, and other shapes and forms. The inks and coatings may be formed on the substrate as a sensor. The inks and coatings may be covered in whole or in part with additional material, such as overcoatings, varnishes, polymers, and fabrics.

The inks and coatings can be applied to the same substrate in varying thicknesses at different points and can be used to build up three-dimensional structures on the substrate. The coatings can be used for the passivation of surfaces, such as metal (e.g. steel, aluminum, etc.) surfaces, including exterior structures such as bridges and buildings. The inks and coatings can be used to make fabrics having electrical conductivity. The inks and coatings can be used to form thermally conductive channels on substrates or to form membranes having desired flow properties and porosities. Such materials could have highly variable and tunable porosities and porosity gradients can be formed. The inks and coatings can be used to form articles having anisotropic thermal conductivities. The inks and coatings can be used to form three-dimensional structures.

The composition can be used to make printed electronic devices (also referred to as “printed electronics) that may be in the form of complete devices, parts or sub elements of devices, electronic components. Printed electronics may be prepared by applying the composition to the substrate in a pattern comprising an electrically conductive pathway designed to achieve the desired electronic device. The pathway may be solid, mostly solid, in a liquid or gel form. The printed electronic devices may take on a wide variety of forms and be used in a large array of applications. They may contain multiple layers of electronic components (e.g. circuits) and/or substrates.

All or part of the printed layer(s) may be covered or coated with another material such as a cover coat, varnish, cover layer, cover films, dielectric coatings, electrolytes and other electrically conductive materials. There may also be one or more materials between the substrate and printed circuits. Layers may include semiconductors, metal foils, and dielectric materials. The printed electronics may further comprise additional components, such as processors, memory chips, other microchips, batteries, resistors, diodes, capacitors, and/or transistors. Other applications that are applicable to the composition include, but are not limited to: passive and active devices and components; electrical and electronic circuitry, integrated circuits; flexible printed circuit boards; transistors; field-effect transistors; microelectromechanical systems (MEMS) devices; microwave circuits; antennas; diffraction gratings; indicators; chipless tags (e.g. for theft deterrence from stores, libraries, etc.); security and theft deterrence devices for retail, library, and other settings; key pads; smart cards; sensors (including gas and biosensors); liquid crystalline displays (LCDs); signage; lighting; flat panel displays; flexible displays, including light-emitting diode, organic light-emitting diode, and polymer light-emitting diode displays; backplanes and frontplanes for displays; electroluminescent and OLED lighting; photovoltaic devices, including backplanes; product identifying chips and devices; membrane switches, batteries, including thin film batteries; electrodes; indicators; printed circuits in portable electronic devices (for example, cellular telephones, computers, personal digital assistants, global positioning system devices, music players, games, calculators, etc.); electronic connections made through hinges or other movable/bendable junctions in electronic devices such as cellular telephones, portable computers, folding keyboards, etc.); wearable electronics; and circuits in vehicles, medical devices, diagnostic devices, instruments.

Articles made from the composition are useful in many environments where they will be used at elevated temperatures. The articles can be used to replace metal components in many applications (including hoses, seals, gaskets, etc.).

Articles made from the composition can be used in environments where they are exposed to hot air and other gases, steams, hot water and other fluids, fuels, lubricants, coolants, hot materials, etc.

Articles made from the composition can include seals, gaskets, o-rings, bushing, cables, cable coatings and jackets, seats, mounts (such as motor or engine mounts), pipes, tubes, hoses, panels, panels, body panels, wire coatings and jackets, belts, tires, couplings, couplings, connectors, joints, insulators, flex joints, valves and valve components, power transfer belts, material handling belts, housings, etc.

Articles made from the composition can be components of pumps, such as vacuum pumps, diaphragm pumps, impeller pumps, piston pumps, positive displacement pumps, etc. They can be components of or serve as pump heads, vanes, float balls, piping, tubing, hoses, seals, connectors, valves, belts, apparel, etc.

Articles made from the composition can be components of water heaters, chemical reactors and production systems, mixers and mills, steam lines and steam handling systems, power plants, furnaces, ovens, kilns, boilers, dryers, furnaces, stoves, food processing equipment, mining and smelting equipment, heating and cooling systems, heat dissipation systems, generators, hot air conveyer systems, conveying systems, etc.

Articles made from the composition can be used as engine and motor components, such as gaskets, belts, tubes and hoses, engine or motor mounts, etc.

Articles made from the composition can be used in fuel transmission lines, natural gas transmission lines, etc.

Articles made from the composition can be used in batteries and other energy capture and storage devices, such as high temperature flow batteries (such as in flow loops and salt baths), solar energy systems (e.g. photovoltaic and thermal collection systems (such as heaters)), geothermal power systems, wind power systems, nuclear power systems, etc.

Articles made from the composition can be used in industrial and manufacturing applications such as furnaces, mills, steel mills, smelters, foundries, cement furnaces, autoclaves, ovens, metallurgy, casting, refining, ceramics, polymers (such as plastics, etc.), glass, minerals, power plants, chemical processing, reactors, food processing, mining, farming, materials transfer systems, piping systems, steam production, safety systems and components, engine rooms (including engine rooms exposed to high steam and other high temperature sources), glass and mineral processing, suction cups for handling hot glass, etc.

Articles made from the composition can be used in electrical systems, such as transformer components, wire and power line coating, sheathing, cladding, jacketing etc., wiring for use in plenum spaces, insulators, etc.

Articles made from the composition can be used in applications where fire retardancy and/or drip suppression are important.

Articles made from the composition can be used as components in weapons systems such as firearms (including small firearms, artillery, etc.), projectile launch tubes (such as torpedo launch tubes). They can be used in explosives and pyrotechnics (including fireworks) systems. etc.

Articles made from the composition can be used in apparel and personal protective equipment for high temperature uses, when exposure to high temperatures is possible, etc. such as that used by industrial workers, welders, construction works, chemical plant workers, foundry workers, emergency personnel (such as firefighters, first responders, rescue workers, hazmat workers, etc.), military personnel, electrical workers, etc. Example include, but are not limited to boots, shoes, and other footwear, gaiters, overboots, spats, chaps, coats, jackets, pants, belts, shirts, undergarments, hoods, visors, glasses, goggles, chin guards, gloves, mittens, smocks, aprons, bibs, overalls, coveralls, hats, hard hats, helmets, respirators, gas masks, blankets, fire curtains, breathing air (such as tanks, such as oxygen tanks) equipment (such as tubing, face masks, etc.), harnesses and lanyards, space suits, etc.

Articles made from the composition can be used as components of conveyer systems, such as belts, rollers, drive rollers, etc. These include conveyer systems that transport materials, ore and finished metal products, food products, etc. They include conveyer systems that transport items to and from ovens, furnaces, kilns, boilers, dryers, and other high temperature sources. Examples of conveyer systems include those used in metal processing and smelting, chemical processing, fuel (e.g. coal, etc.) transport and feeding, assembly and production lines (such as those used to make automobiles and other vehicles), casting (such as metal casting), packaging, waste handling and recycling, etc.

Where metal roller and other components can be replaced, articles made from the composition can offer an increased coefficient of friction that can reduce belt wear.

Articles made from the composition can be used as comments of high temperature printing systems (e.g. laser printing, digital printing, flexographic printing, gravure printing, etc., such as fusers, belts, and gears).

Articles made from the composition can be used in aerospace, aviation, space exploration, etc. applications. Examples include aircraft, airplanes, helicopters, rockets, satellites, booster engines, re-entry vehicles, balloons (including weather balloons, weather balloons), airships, blimps, dirigibles, drones, space shuttles, space stations, interplanetary and intergalactic exploration devices and vehicles, etc.

Articles made from the composition can be used in automotive applications, such as engine mounts, belts, timing belts, drive belts, transmission belts, seals, gaskets, boots (e.g. constant velocity boots), body panels, heaters, tubing, and coolant system components.

Articles made from the composition can be used for cooking and baking (e.g., heat resistant cookware and bakeware) and laboratory equipment.

What is claimed is:

1. A conductive composition comprising, graphene sheets, graphite, and carbon black, wherein the graphene sheets are present in about 0.2 to about 10 weight percent relative to the total weight of graphene sheets, graphite, and carbon black.

2. The conductive composition of claim 1, wherein the weight percent of graphene sheets relative to the total weight of graphene sheets, graphite, and carbon black is about 0.2 to about 5.

3. The conductive composition of claim 1, wherein the graphene sheets have a surface area of at least about 100 m²/g.

4. The conductive composition of claim 1, wherein the weight percent of graphene sheets relative to the total weight of graphene sheets, graphite, and carbon black is about 0.2 to about 3.

5. The conductive composition of claim 1, further comprising a polymer.

6. The conductive composition of claim 1, wherein the composition has a surface resistance of about 0.1 to about 50 Ω/square/mil or less.

7. A conductive ink or coating comprising: a composition having graphene sheets, graphite, and carbon black, wherein the graphene sheets are present in about 0.2 to about 10 weight percent relative to the total weight of graphene sheets, graphite, and carbon black.

8. The conductive ink or coating of claim 7, wherein the weight percent of graphene sheets relative to the total weight of graphene sheets, graphite, and carbon black is about 0.2 to about 5.

9. The conductive ink or coating of claim 7, wherein the graphene sheets has a surface area of at least about 100 m²/g.

10. The conductive ink or coating of claim 7, wherein the weight percent of graphene sheets relative to the total weight of graphene sheets, graphite, and carbon black is about 0.2 to about 3.

11. The conductive ink or coating of claim 7, further comprising a polymer.

12. The conductive ink or coating of claim 7, wherein the composition has a surface resistance of about 0.1 to about 50 Ω/square/mil or less.

13. An article coated with the conductive ink or coating of claim 7.

14. The article of claim 19, wherein the conductive ink or coating is formed on the article as a film, a line, a pattern, a letter, a number, a circuit, a logo, an identification tag, a printed circuit, and/or a sensor.

15. The article of claim 19, wherein the article is comprised of one or more of a film, a cellulose-based material, a three-dimensional object, and a metal.

16. An article comprising the conductive composition of claim 1.
